(19) United States
(12) Patent Application Publication
(10) Pub. No.: US 2011/0209923 A1
(43) Pub. Date: Sep. 1, 2011

(54) Method and Device for Weighing Objects of Different Weight Classes

(75) Inventors: Holger Schererz, Rehfelde (DE); Frank Voss, Berlin (DE)

(73) Assignee: Siemens Aktiengesellschaft, Munchen (DE)

(21) Appl. No.: 13/036,747

(22) Filed: Feb. 28, 2011

Related U.S. Application Data
(60) Provisional application No. 61/308,693, filed on Feb. 26, 2010.

(51) Int. Cl. G01G 19/414

(52) U.S. Cl. 177/1; 177/25.13

(57) ABSTRACT

A method and device for weighing at least one object, particularly a mail item, includes a scale for weighing an object with a first tolerance in a first operating mode if the object has a first property and for weighing the object with a second tolerance in a second operating mode if the object has a second property. Before weighing an object in the first operating mode, it is checked for the first property. If it is not ruled out that the object has the first property, the scale weighs the object when the scale is operated in the first operating mode, and the measurement result is used as the weight of the object. Otherwise, the scale is switched to the second operating mode. The scale weighs the fed-in object again. If the object has the second property, the measured value is used as the weight of the object.

### CROSS-REFERENCE TO RELATED APPLICATION

This application claims the priority, under 35 U.S.C. §119(e), of U.S. Provisional Patent Application No. 61/308,693, filed Feb. 26, 2010; the prior application is herewith incorporated by reference in its entirety.

### BACKGROUND OF THE INVENTION

### Field of the Invention

The invention relates to a method and a device for weighing objects of different weight classes, in particular flat items of mail of different weight classes.

The objective of weighing the weight of an object occurs, for example, when the object is an item of mail and is to be transported against payment of a forwarding fee. European Measuring Instruments Directive (MID) 2004/22/EC requires that the measuring devices which measure the fee-related parameters of an object to be transported be checked in terms of type of construction and calibrated.

As a rule, the forwarding fee for transporting an object depends on its weight. The procedure of weighing the object and determining the forwarding fee as a function of the measured mass is known. A scale measures the deflection or the force which the object brings about or exerts.

German Patent DE 198 60 295 C2, corresponding to U.S. Pat. Nos. 6,472,616 and 6,353,192, describes a method and a device for controlling a dynamic scale. The configuration shown in FIG. 1 thereof includes a scale 10 which weighs items of mail that are in an upright position. A transportation apparatus 4 transports the items of mail over the scale. FIG. 2 shows a block circuit diagram of the described device. A control unit 20 actuates a motor 49 of the transportation apparatus through the use of a microprocessor 21 and receives measurement data from a weighing cell 7 of the scale 10 and from sensors S1, S2 which measure the movement of items of mail. The scale 10 calculates a reference postal rate for an item of mail from the measured weight and from further postal information through the use of a program memory 22.

A user prescribes postal information through the use of an input unit, shown in FIG. 3. FIG. 5 shows a screen mask for setting the scale 10. In that case, various modes can be predefined for the scale, for example “weighing” and “not weighing.” In a further mode, the scale monitors whether an item of mail is lighter in weight than a lower threshold value or heavier than an upper threshold value, see FIG. 7 and FIG. 8, respectively. Such items of mail can then be set aside. Furthermore, a user can predefine the measurement range, the measurement tolerance and the transportation speed (FIG. 9). Empirically determined relationships between those three parameters, specifically the measurement range, the measurement tolerance and the transportation speed, are stored in a data memory 23.

U.S. Pat. No. 5,174,398, corresponding to European Patent EP 49 57 02 B1, describes a scale which can be operated in three different modes. A user is able to predefine a mode through the use of an operator control unit with a keyboard 12. The scale (“scale 16”) supplies measured values to a “CPU 10.” The “CPU 10” actuates a “postage meter 18” and a “display 20.” In a first mode (“shipping mode”) the scale 16 measures an object in a more approximate manner (“coarse”) than in a second mode (“commercial mode”). For example, possible measured values in the first mode differ by 0.5 ounces, and in the second mode by 0.1 ounces. In one embodiment, the accuracy with which the scale outputs a measurement result depends on the weight of the object to be weighed. In a third mode (“fast weighing mode”) allowance is made for the fact that the object on the scale is oscillating. For that reason, the object is weighed several times in succession. As soon as the measured values all lie in a tolerance range, a mean value of those measured values is used as the weight. FIG. 2 illustrates how measurement is carried out incrementally in the various modes.

German Published Patent Application DE 199 11 514 A1 describes a device which determines the necessary postal rate for an item of mail and franks or stamps the item of mail. That device is capable of operating in two different modes. FIG. 1 shows the device with a processing unit 3, a determining unit 2 and a franking or postage machine 4. The processing unit 3 measures items of mail through the use of a weighing cell 11 and also measures the dimensions of the item of mail. The franking machine 3 franks the items of mail. In the first operating mode, a postal rate table with y different postal charges is stored in the franking machine 3 and used. The franking machine 3 uses n input data items from an item of mail in order to select the correct postal charge from the table with the y postal charges. In the second operating mode, the franking machine 3 uses a reduced table with only x different postal charges, and requires in that case only m<n input data items, for which reason the franking machine operates more quickly in the second operating mode.

However, the weighing operation requires a certain period of time because the scale has to finish oscillating before it supplies a reliable measured value. Various methods have been proposed for compensating for that disadvantage.

U.S. Pat. No. 6,107,579 describes a method in which a plurality of scales operate in parallel. The objects to be weighed are distributed on at least two parallel transportation paths. A scale is located on each transportation path. The transportation paths run together again at a junction point. As a result, the throughput rate through the device is almost N times higher than the throughput rate through an individual scale, where N is the number of scales operating in parallel.

Furthermore, methods for measuring the object indirectly have been repeatedly described. In those methods, in each case at least one other measurement variable is measured in order to save time, and the weight is calculated from that measurement result.

U.S. Patent Application Publication No. US 2004/0173386 A1 proposes measuring the format of an item of mail and calculating the mass from the measured format.

In the method described in U.S. Pat. No. 7,162,459, the volume of an item of mail is measured. The mass of the item of mail is calculated from that volume and from a predefined density for paper. However, the problem arises that many items of mail are not only composed of paper but also, for example, contain a check card or a number plate. For that reason, the volume and a further measurement variable are measured, for example the flexural strength or a geometric measurement variable for the “dimensional uniformity” of the item of mail or else electromagnetic properties of the item of mail in a predefined magnetic field. If the further measurement variable exhibits an anomaly of the item of mail, the item of mail is handled separately. Otherwise, the weight is calculated from the volume of the item of mail and from the predefined density of paper.

German Published Patent Application DE 198 58 229 B4 describes a method and a device for weighing objects. The object to be transported, in German Published Patent Application DE 198 58 229 B4, an item of mail, is initially weighed automatically, specifically through the use of a dynamic scale. The volume of the item of mail is also determined. It is checked whether the item of mail is sufficiently franked. The measured weight and the measured volume of the item of mail are used for that checking operation. An item of mail which is not sufficiently franked is set aside. The weight of a set-aside item of mail is subsequently measured manually, specifically through the use of a static scale.

European Patent EP 14 38 145 B1, corresponding to U.S. Patent Application Publication No. US 2005/0167342 and European Patent EP 14 38 148 B1, corresponding to U.S. Patent Application Publication No. US 2005/0006286, also describe a method with which it is checked whether or not an item of mail has sufficient franking. That checking operation is carried out automatically through the use of a sorting system which has a reading device and a video encoding machine. A checked item of mail is provided with a fee confirmation code. An item of mail which is not sufficiently franked is set aside.

U.S. Patent Application Publication No. US 2004/0054547 A1 describes how a stack of items of mail (“batch of mail items”) is processed. Each item of mail is measured. A log is generated as a function of the measurement results and transmitted to a carrier which also transports the stack.

German Published Patent Application DE 10 337 164 A1, corresponding to U.S. Patent Application Publication No. US 2007/0000818, proposes evaluating in two stages graphic information which is provided on items of mail.

European Patent Application EP 16 19 630 A2, corresponding to U.S. Pat. No. 7,707,123, describes a method for reimbursing the previously paid postal rate for a franking imprint if the franking imprint cannot be used.

International Publication No. WO 99/21138 A2 proposes collecting items of mail which have not yet been franked in a container and measuring and franking those items of mail. The sender is presented with a bill, for which the sender can bring about automatic payment.

### SUMMARY OF THE INVENTION

It is accordingly an object of the invention to provide a method and a device for weighing objects of different weight classes, which overcome the hereinafore-mentioned disadvantages of the heretofore-known methods and devices of this general type and in which before a weighing operation it is not known to which weight class of two predefined weight classes the weight of the object belongs and in which it is not necessary to use a respective scale for each weight class.

With the foregoing and other objects in view there is provided, in accordance with the invention, a method and a device for weighing objects of different weight classes, as described below:

According to the invention, at least one object is weighed through the use of a scale. This scale can be operated in a first operating mode and in a second operating mode. If the scale is operated in the first operating mode, the scale is capable of weighing, with a predefined first tolerance, any object which has a predefined first physical property. If the scale is operated in the second operating mode, the scale is capable of weighing, with a predefined second tolerance, any object which has a predefined second physical property.

At least one of the two following steps is carried out for each object to be weighed:

It is checked automatically whether or not the object has the first property.

The scale weighs the object when the scale is being operated in the first operating mode.

It is possible that both steps are carried out for each object to be weighed. It is also possible firstly to carry out the checking operation and to weigh, or not weigh, the object in the first operating mode as a function of the result of the check.

An object to be weighed is always weighed by the scale in the first operating mode if at least one of the two following conditions is met:

It has been decided or predicted before the weighing in the first operating mode that the object has the first property.

The step for checking whether or not the object has the first property was not carried out before the weighing in the first operating mode, i.e. each object to be weighed is weighed in the first operating mode.

The scale is then switched over to the second operating mode if at least one of the following two conditions is met for at least one object which is to be weighed:

The step in which the scale weighs the object in the first operating mode was not carried out because it was already decided or predicted before this weighing that the object does not have the first property.

After the weighing of the object in the first operating mode it was decided that the object does not have the first property. The measured value used in the first operating mode is preferably used for this decision.

Each object which is to be weighed and which meets at least one of the following two conditions is weighed by the scale when the scale is being operated in the second operating mode:

The object does not have the first property.

The object was not weighed in the first operating mode.

For each object to be weighed, the following measured value is used as the weight of that object:

The measured value which is measured in the first operating mode is used as the weight if it has been decided that the object has the first property.

The measured value which is measured in the second operating mode is used as the weight if it has been decided that the object has the second property.

It is possible that an object to be weighed has neither the first nor the second property. The method then does not provide any weight.

The method can be applied, in particular, if a weight is to be weighed by a certified scale and this scale is capable of weighing specific objects in specific operating modes.

The method and the device according to the invention require only one scale. The scale therefore avoids the need to make available a first scale for objects with the first property and a second scale for objects with the second property. In particular, the invention makes it superfluous for the device to have a plurality of scales for different weight classes.

Furthermore, it is not necessary to split up a stream of objects into multiple partial streams before the weighing and to respectively direct each partial stream to a separate scale. Additionally, this one scale does not need to be embodied to be able to weigh all the objects with a predefined tolerance in a single operating mode. Such a universal scale is often not available commercially or costs too much or does not attain the necessary throughput rate of objects.

Furthermore, by virtue of the invention it is not necessary to switch over the scale from the first operating mode to the second operating mode during a weighing process. This is frequently not at all possible during the weighing process. In particular, it is not necessary to switch over the scale while the object is transported over the scale or past the scale in some other way and the scale records or processes signals.

By virtue of the invention it is not necessary to have to change a setting of the scale manually during ongoing operation. Instead, the scale is capable of determining automatically whether or not an object to be weighed has the first physical property, and the scale can be operated automatically in the first operating mode or in the second operating mode.

Since just one scale is required, the invention makes it unnecessary to connect two different scales in parallel or in series. The invention therefore avoids the use of different scales. Furthermore, by virtue of the invention it is not necessary to provide a separating switch and/or additional transportation paths. Additionally, it is possible, but not absolutely necessary, to divide the objects in advance into two sets—a first set with all the objects which have the first property, and a second set with all the objects which have the second property.

The invention provides that an object is weighed twice if the scale does not weigh the object when the scale is operating in the first operating mode or if it has been detected that the object does not have the first property. It is not necessary to have prior knowledge as to which objects to be weighed have or do not have the first property.

The method can be integrated into an existing processing apparatus with a scale, wherein the processing apparatus originally was able to process only objects with the first property, and the original scale was able to weigh only those objects during the processing. In order to ensure that this processing apparatus can additionally process and weigh objects with the second property, all that is necessary is to adapt the scale. Each object passes through the processing apparatus at least once in precisely the same way as before the functional extension. Objects with the second property pass through this processing apparatus twice, preferably both times on the same transportation path. As a result, there is no need for a “bypass,” delay section or separating switch. However, it is possible to provide a “bypass” which is used if the scale is being operated in the first operating mode.

The method requires a further pass of the object and repeated transportation over the scale or past the scale in some other way only if it is detected before or after the weighing in the first operating mode that the object does not have the first property. Before the weighing in the second operating mode it is not necessary to know whether or not the object has the second property. The smaller the number of objects to be processed which have the second property and do not have the first property, the less frequent the need to carry out this repeated pass.

All the objects with the first property preferably belong to a first weight class, and all the objects with the second property belong to a second weight class. Whether an object has the first or the second property or neither of the two properties can depend on at least one further parameter, e.g. a dimension or a surface quality or a shape or a contour of the object. An object to be weighed can have either the first or the second property. Whether or not an object has the first property can depend on the weight and on the values of a plurality of further physical parameters. The same applies to the second property.

The object is preferably transported past the scale at a first transportation speed when the scale is being operated in the first operating mode. The object is transported past the scale at a second transportation speed when the scale is being operated in the second operating mode. The objects in this context are preferably transported over the scale so that the weight of the objects acts in the direction of the scale. The first transportation speed is higher than the second transportation speed. The object is transported over the scale or past the scale in some other way in both operating modes without stopping, and the scale weighs the transported object. This embodiment permits a high throughput rate while complying with the predefined tolerances. The throughput rate is particularly high if significantly more objects to be weighed have the first property than there are objects to be weighed without the first property.

A set of objects is preferably weighed. The scale is initially operated in the first operating mode and successively weighs the objects in the set. Each object which does not have the first property is fed to the scale again. A control unit therefore receives measured values from the scale. A separating switch is disposed downstream of the scale in a transportation path. The control unit actuates the separating switch in such a way that the separating switch directs an object which does not have the first property into a return path which transports the object back to the scale. In one refinement, only those objects which have the second property and which do not have the first property are fed to the scale again.

The scale, which is now being operated in the second operating mode, successively weighs all the objects which have been supplied again, and therefore also all those objects which were previously not weighed at all by the scale, or were not weighed with a predefined tolerance by the scale.

The method is preferably embodied in such a way that when the scale is being operated in the first operating mode it is capable of weighing all those objects having a respective weight which is below a weight threshold. Only relatively heavy objects are weighed firstly when they pass through again.

In accordance with another mode of the invention, the measurement result which is supplied by the scale when the scale is being operated in the first operating mode is used for the decision as to whether or not an object to be weighed has the first property. In particular, the measurement result is used for the decision as to whether the object is lighter in weight than a predefined weight threshold. This embodiment avoids the need for a “bypass” around the scale for objects which do not have the first property. Furthermore, the embodiment avoids the need for an additional measuring device for a further parameter. Although the measurement result of the scale can have a measuring error which is greater than the first tolerance, this measurement result is often sufficient for the decision as to whether or not the object has the first property.

In another embodiment, the objects are divided in advance into two different sets, specifically a first set with all the objects with the first property and a second set with all the objects without the first property. This division can be carried out on the basis of the weight or of some other physical parameter, for example a dimension of the object. The objects of the first set are initially transported past the scale, preferably over the scale. The scale weighs all the objects of the first set when the scale is being operated in the first operating mode. The scale is subsequently switched over to the second operating mode. All the objects of the second set are transported past the scale. The scale then weighs all the objects of the second set.

This embodiment prevents the scale from having to weigh an object while the scale is being operated in the first operating mode even though the object does not have the first property, that is to say is, for example, too heavy or too large.

This avoids the situation in which the weighing of a heavy object causes the scale to experience natural oscillations which last for a relatively long time and nevertheless this measured value cannot be used because the scale has been operated in the first operating mode but the weight of the object is above a weight threshold, or the object has a shape or contour or surface quality which is unsuitable for weighing.

In a third embodiment, all the objects are transported in advance over the scale when the scale is being operated in the first operating mode. However, the scale is switched off and preferably locked before an object which does not have the first property reaches the scale. The scale does not weigh this object. Before an object with the first property reaches the scale, the scale is switched on again and the scale weighs the object. This embodiment also avoids long natural oscillations due to a heavy object and at the same time avoids the need to provide a separating switch and a “bypass.”

The scale can include a single weighing cell or else a plurality of weighing cells of the same type which are connected in parallel. A stream of objects is divided into a plurality of partial streams upstream of the scale, and the partial streams are combined again to form one stream, to be precise preferably downstream of the scale. Each weighing cell weighs the objects of one partial stream.

The invention can be used, for example, for items of mail, travelers' baggage items, pieces of freight, for example for transportation by sea, rail or air, and for classifying objects.

Other features which are considered as characteristic for the invention are set forth in the appended claims.

Although the invention is illustrated and described herein as embodied in a method and a device for weighing objects of different weight classes, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic and block diagram of a sorting system which is used according to the invention;

FIG. 2 is a flowchart of a first embodiment in which every item of mail is transported over a scale when the scale is being operated in a first operating mode;

FIG. 3 is a flowchart for a step in FIG. 2 of weighing an object in a second operating mode;

FIG. 4 is a flowchart for a refinement in which the scale weighs only objects with a first property when the scale is in the first operating mode; and

FIG. 5 is a flowchart for a refinement in which only items of mail which are suspected of having insufficient postage are weighed in a way which is MID-compatible.

### DETAILED DESCRIPTION OF THE INVENTION

In the exemplary embodiment, the method is used in order to sort a set of flat items of mail (standard letters, oversized letters, postcards, catalogs and the like) and to weigh them during the sorting process. Each item of mail is to be transported to a respectively predefined destination address.

In one embodiment, the respective sender has provided an item of mail with a franking mark (stamp, franking emblem, encoded franking mark, “indicia”). This franking mark defines which actual forwarding fee has already been paid by the sender for a carrier to transport the item of mail. The actual forwarding fee can differ from a reference forwarding fee. This reference forwarding fee depends on various fee-related parameters, inter alia on the weight of the item of mail. The carrier, generally a postal service worker, would like to check whether the item of mail is sufficiently franked, that is to say whether the actual forwarding fee which has been in fact paid is higher than or equal to the necessary reference forwarding fee. The item of mail has to be weighed for this checking process. This is because the reference forwarding fee depends on the weight of the item of mail.

In another embodiment, a single sender mails a set of items of mail. These items of mail are preferably items of mail of the same type, for example letters of the same type or various examples of the same issue of a periodical or of catalog. It is also possible that the items of mail from the same sender have different dimensions and/or differ in weight. These items of mail are not yet provided with franking marks. The carrier itself provides the items of mail with franking marks during the transportation and produces a bill for the sender for the entire forwarding fee for all items of mail after the transportation. The bill is preferably generated automatically. This embodiment also requires the carrier to weigh the items of mail in order to calculate the respective forwarding fee.

At least in this case, the carrier is legally obliged to measure the fee-related parameters and, in particular, the weight with calibrated measuring devices.

In both embodiments, the measuring instruments which measure the fee-related parameters, in particular the scale which is used, must be checked with respect to construction and calibrated. In Europe this is prescribed by the MID mentioned above.

The items of mail are sorted with a sorting system. This sorting system determines the respective destination address of each item of mail and triggers onward transportation of the item of mail to this destination address.

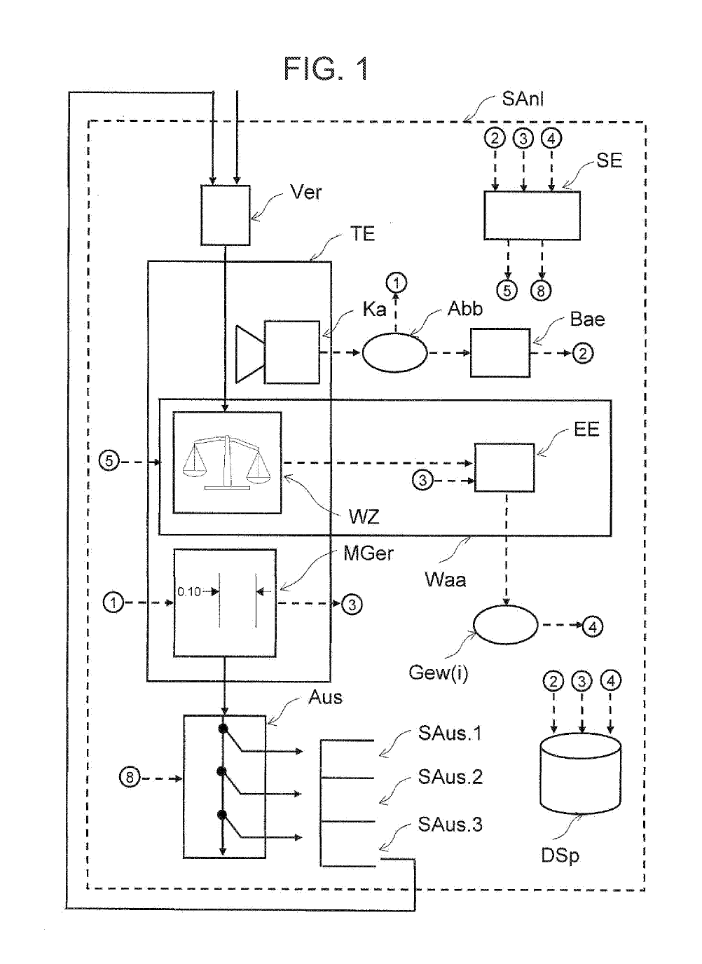

Referring now to the figures of the drawings in detail and first, particularly, to FIG. 1 thereof, there is seen a schematic and block diagram of a sorting system which is used for processing and weighing the items of mail. This sorting system SAnl includes the following components:

a separator (“singulator”) Ver which separates items of mail so that a stream of items of mail which are spaced apart from one another and in an upright position leaves the separator,

a camera Ka which generates in each case a computer-compatible image Abb of each item of mail,

an image evaluation unit Bae which evaluates a computer-compatible image Abb of an item of mail and deciphers the respective destination address in the image,

a measuring device MGer which measures the thickness and, when appropriate, further dimensions of an item of mail and uses the image Abb of this item of mail for this purpose,

a transportation apparatus TE,

a scale Waa,

a removal apparatus Aus,

three exemplary sorting outlets SAus.1, SAus.2, SAus.3, and

a control unit SE.

The scale Waa includes

a decision unit EE, and

at least one weighing cell WZ.

FIG. 1 illustrates material flows with continuous arrows, and data flows with dashed arrows.

The following are transmitted to the decision unit EE:

the measured values from the measuring device MGer, and

the measured values from the weighing cell WZ.

The decision unit EE is capable of automatically deciding whether an item of mail Ps(i) has the predefined first property or not, and whether the item of mail Ps(i) has the second property or not. For this purpose, the decision unit EE evaluates the measured values from the measuring device MGer and from the weighing cell WZ. The decision unit EE outputs a measured weight Gew(i) of an item of mail Ps(i). Furthermore, the decision unit EE transmits decisions to the control unit SE.

The following are transmitted to the control unit SE:

the evaluation result of the image evaluation unit Bae, and

the decisions from the decision unit EE.

The control unit SE actuates the following components of the sorting system SAnl:

the scale Waa in order to place the scale Waa in a specific operating mode, and

the removal apparatus Aus in order to set aside an item of mail into a previously selected sorting outlet SAus.1, SAus.2, SAus.3.

The transportation apparatus TE transports items of mail past the camera Ka and over the weighing cell WZ. The transportation apparatus TE can be actuated in such a way that the transportation apparatus TE transports items of mail either at a first transportation speed v1 or at a second transportation speed v2, wherein the second transportation speed v2 is lower than the first transportation speed v1.

Items of mail from the sorting outlet SAus.3 are sent back to the separator Ver again and pass through the sorting system SAnl again.

In one embodiment, the camera Ka generates a computer-compatible image Abb of the item of mail. The evaluation unit Bae evaluates this image and deciphers the destination address in the image. The evaluation unit Bae includes an OCR unit which attempts automatically to decipher the information about the destination address in the image Abb by “optical character recognition” (OCR). If this is not successful, in one refinement the image Abb of the surface of the item of mail is transmitted to a video encoding station and represented on a screen of this video encoding station. An operator reads the destination address in the illustrated image Abb and enters information about the destination address, for example the zip code, through the use of an input device, for example a keypad.

In another embodiment, the sender mails the items of mail of the same type without a franking mark and without a destination address. Furthermore, the sender submits a computer-compatible listing with the destination addresses of the items of mail to the carrier. The carrier itself determines the respectively necessary forwarding fee and itself provides the items of mail with the respective destination address.

In a further embodiment, a sender mails a large number of items of mail of the same type. Each item of mail is provided with a destination address and has no franking mark. The carrier itself determines the respective forwarding fee for each item of mail and provides the sender with a bill for the transportation of these items of mail. This also requires each item of mail to be weighed with a certified scale.

In a further embodiment, the respective destination address of each item of mail was determined in a preceding sorting run and stored. In the respective sorting run in which the items of mail have to be weighed, the stored destination address is determined, for example by reading a printed-on barcode or identifying the item of mail on the basis of a feature value vector.

In the exemplary embodiment, a data record is respectively generated for each item of mail. This data record includes an internal identifier which uniquely identifies the item of mail, and an identification of the read or submitted destination address. This data record is stored in a central data memory DSp. The data record is generated as soon as the item of mail Ps(i) is transported past the camera Ka. The data record is later supplemented with further information, for example with the deciphered destination address and with the measured weight Gew(i).

The sorting system SAnl has the calibrated scale Waa and the control unit SE. In order to weigh the objects, that is to say in this case the items of mail, this calibrated scale Waa is used. The scale Waa is checked and calibrated, for example, in accordance with the European Measuring Instruments Directive (MID) 2004/22/EC, and meets the requirements of this MID. The part MID-006 regulates automatic scales.

The scale Waa supplies in each case a measured value for each item of mail, which measured value is used as the weight of the item of mail—unless the weight of the item of mail is neither in a first weight class nor in a second weight class. This measured value which the scale Waa supplies is used in particular to calculate a reference forwarding fee for the item of mail. The data record for this item of mail in the central data memory DSp is supplemented by an identification of the measured weight.

The control unit SE receives measured values from the sensors of the scale Waa and actuates the scale Waa and further components of the sorting system SAnl. Functions of the decision unit EE and/or of the control unit SE are preferably implemented in a controller of the scale itself. In order to meet legal requirements, the decision as to whether or not a measured value of the scale Waa is in a predefined weight class is carried out in the exemplary embodiment by the decision unit EE in the scale Waa and not by a decision unit outside the scale. The decision unit EE or a separate scale controller also causes a measured value of the scale to be stored in a tamper-proof fashion in an “alibi memory.”

The data record is locked to prevent subsequent change in such a way that if necessary it can be used to provide legal evidence as to the actual weight of the item of mail, i.e. what measured value the scale calibrated according to MID has supplied. In order to avoid subsequent changes of the stored values of the fee-related parameters, the data records are preferably stored in what is referred to as an “alibi memory.”

In the exemplary embodiment, further fee-related parameters of the item of mail are measured, in particular the three dimensions of length, height and thickness of the item of mail. The measuring device MGer supplies these dimensions. The forwarding fee can also depend on the destination address and on mailing instructions (“endorsements”) of the sender, for example dispatched to an Asian country by registered mail. These three dimensions are also stored in the data record in such a way that subsequent changes to the dimensions are not possible, preferably by “alibi memory.”

A calculation unit calculates the reference forwarding fee for the item of mail and for this purpose uses the weight and the values of the further fee-related parameters. An identification of the reference forwarding fee is stored in the data record. If the sender itself has provided the items of mail with a franking mark, an identification of the determined actual forwarding fee is also stored in the data record.

Two weight classes for items of mail are differentiated in the exemplary embodiment. Which two weight classes these are depends specifically on the carrier. The following weight classes are differentiated:

a first weight class with a range between 5 g and a first upper limit which lies between 100 g and 150 g, and

a second weight class with a range between 10 g and a second upper limit which lies between 300 g and 480 g.

The two weight classes therefore overlap. Most of the items of mail of the first weight class also belong to the second weight class. In one refinement of the exemplary embodiment the first weight class functions as the first property, and the second weight class as the second property which an object (in this case an item of mail) has or does not have.

The scale Waa can be operated in two operating modes, specifically in a way which is compatible with MID 006 in both operating modes. In the first operating mode, the scale Waa is capable of weighing an object, that is to say for example an item of mail, of the first weight class with a predefined first tolerance of ±1 g. It is therefore ensured that the measured value which the scale supplies deviates by at maximum 1 g from the actual weight if the actual weight is in the first weight class and the scale Waa is being operated in the first operating mode. In the second operating mode, the scale Waa is capable of weighing an object with a predefined second tolerance of ±2 g if the actual weight of the object is in the second weight class and the scale Waa is being operated in the second operating mode.

The scale Waa is capable of weighing an object while this object is being transported over the scale Waa. For example, it is measured how far the weight of the object deflects a measuring sensor in the downward direction. Or it is measured which force is necessary to compensate the weight of the object. The actual weighing is carried out by the weighing cell WZ. In the first operating mode, the scale Waa is capable of ensuring the first tolerance described above when the object belongs to the first weight class and is transported at a first transportation speed v1 over the scale Waa or past the scale in some other way, wherein the first transportation speed v1 is lower than or equal to a first predefined speed threshold v1_th. The threshold v1_th is, for example, between 3.5 m/sec and 4.0 m/sec. In the second operating mode, the scale Waa is capable of ensuring the second tolerance described above when the object is transported at a second transportation speed v2 over the scale Waa or past the scale Waa in some other way, wherein the second transportation speed v2 is lower than or equal to a second speed threshold v2_th. The threshold v2_th is, for example, between 2.0 m/sec and 2.5 m/sec, wherein the object belongs to the second weight class.

In one implementation, the scale Waa is capable of weighing each object of the first weight class while this object is being transported at a transportation speed v1 of lower than or equal to the threshold v1_th over the scale. In this implementation, an object has the first property if its weight is in the first weight class. The scale Waa is capable of weighing the object of the second weight class while this object is being transported at a transportation speed v2 of lower than or equal to the threshold v2_th over the scale. In this implementation, an object always has the second property if its weight is in the second weight class. The second speed threshold v2_th is lower than the first speed threshold v1_th.

In a second implementation, the scale Waa is capable of weighing an object with the predefined first tolerance in the first operating mode only if the weight of the object is in the first weight class, and in addition the value which a further physical parameter for this item of mail assumes is in a predefined value range. For example, a dimension (length, height, thickness) of the object must not be above a predefined threshold. In this case, an object has the first property if its weight is in the first weight class and its dimensions are in the predefined first dimension ranges. The object is then, for example, a standard letter (in the USA: a “letter”). An object has the second property if its weight is in the second weight class and its dimensions are in the predefined second dimension ranges. An object which has the second property but not the first property is, for example, an oversized letter (in the USA: a “flat”).

In the exemplary embodiment, an item of mail has the first property if its weight is in the first weight class and the item of mail belongs to a first format class due to its dimensions. An item of mail has the second property if its weight is in the second weight class and the item of mail belongs to a second format class due to its dimensions. The two weight classes overlap. The first format class is a subset of the second format class.

In the text which follows, mention is made continuously of “the first property” and “the second property.” The weight of an object with the first property is always in the first weight class. The weight of an object with the second property is always in the second weight class.

The scale Waa can be switched over automatically from the first operating mode to the second operating mode and vice versa from the second operating mode to the first operating mode by actuation from the outside. For the purpose of switching over, new values are assigned from the outside to various internal parameters of the scale Waa. In the configuration in FIG. 1, the control unit SE actuates a scale controller, which itself changes the parameters of the scale Waa accordingly.

In one embodiment, a system operator switches over the scale Waa. In order to do this, the system operator uses an operator control unit of the sorting system SAnl with a screen device and suitable input devices, for example touch-sensitive areas on the screen or various operator control buttons. In another embodiment, the control unit SE transmits corresponding data or control instructions for switching over to the scale Waa through an interface. However, this manual or automatic switching over can be carried out in the exemplary embodiment only if the scale Waa is not weighing any items of mail at that particular time.

In one embodiment, the scale Waa is capable of supplying a measurement signal even if the scale Waa is being operated in the first operating mode and is weighing an object which does not have the first property. Although this measurement signal cannot be used as the weight of the object which has been measured in an MID-compatible fashion, it can be evaluated automatically in order to decide that this object does not have the first property because its weight is outside the first weight class.

In the exemplary embodiment, the scale Waa which is being operated in the second operating mode is capable of supplying a measured value even if the object to be weighed does not have the second property. The measurement result which is acquired in the second operating mode can therefore be used for the decision as to whether or not a measured value which is acquired in the second operating mode is used as an MID-compatible weight.

In one embodiment, the scale Waa has a single weighing cell WZ. In another embodiment, the scale Waa has multiple weighing cells which are connected in parallel, for example as described in U.S. Pat. No. 6,107,579. These weighing cells are preferably embodied in the same way. A stream of items of mail to be weighed is divided into a plurality of partial streams, specifically one partial stream per weighing cell. Each partial stream is transported over the assigned weighing cell. Each weighing cell respectively supplies a measured value for each item of mail which is transported over this weighing cell. The partial streams are combined again to form a single stream downstream of the weighing cells which are connected in parallel. In both embodiments, every item of mail is held by the transportation apparatus TE during the weighing.

The scale Waa is initially operated in the first operating mode. All items of mail successively pass through the sorting system SAnl. The flat items of mail are preferably transported in an upright position on one edge.

In one embodiment, each item of mail is transported while being continuously held by the transportation apparatus TE. Each item of mail is preferably held, in each case, by two continuous conveyor belts at any time, which continuous conveyor belts are guided around two vertical rollers or axles and rotate at the same speed. As a result, the item of mail is transported virtually without slip. In another embodiment, the item of mail is transported in a transportation channel. In this context, the item of mail stands on the floor and leans against a side wall of this transportation channel. The bottom of the transportation channel is preferably formed by a sequence of underfloor conveyor belts. The side walls can also include continuous conveyor belts.

In a first embodiment, each item of mail is transported over the scale Waa, specifically at a first transportation speed v1, which does not exceed the first speed threshold v1_th. The first speed threshold v1_th is, for example, between 3.5 m/sec and 4.0 m/sec. The first transportation speed v1 is preferably higher than the second speed threshold v2_th, with the result that in the first operating mode the scale attains a higher throughput rate than in the second operating mode because more items of mail per time unit are transported over the at least one weighing cell WZ of the scale Waa.

The scale Waa respectively supplies for each item of mail a measured value which has been acquired in the first operating mode. This measured value is transmitted to the decision unit EE. This decision unit EE checks whether or not the supplied measured value is in the first weight class.

If the measured value is in the first weight class and the object also has the first property with respect to its dimensions, the measured value is used as the weight of the item of mail. The decision unit EE outputs this weight by virtue of the fact that, for example, the decision unit EE transmits the measured weight to the control unit SE. The item of mail is processed in a normal, further processing step and is then set aside into one of a plurality of predefined sorting end points SAus.1, SAus.2, . . . etc. An identification of this measured value is added to the data record for the item of mail in the central data memory DSp.

On the other hand, if the measured value which the scale Waa supplies in the first operating mode after the weighing is outside the first weight class, the decision unit EE decides automatically that the weight of the item of mail is not in the first weight class, and the object therefore does not have the first property, and the measured value therefore cannot be used as the weight of the item of mail. The item of mail is set aside into a special sorting end point SAus.3. This applies both to items of mail which have the second property and not the first property, as well as to items of mail which have neither the first nor the second property.

If, after the first processing of the items of mail, no item of mail has been set aside into this specific sorting end point SAus.3, the weighing of the item of mail is terminated. This is because the scale Waa was able to weigh all the items of mail in an MID-compatible fashion. Otherwise, that is to say if at least one item of mail has been set aside into the special sorting end point SAus.3, the following steps are carried out:

The scale Waa is switched over to the second operating mode. This switching over is either carried out automatically by the decision unit EE or manually by a system operator.

The items of mail from the special sorting end point SAus.3 are again fed to the separator Ver and pass again through the sorting system SAnl.

In the process, these items of mail are again transported over the scale Waa, specifically at a second transportation speed v2, which is lower than the first transportation speed v1 and lower than or equal to the second upper speed threshold v2_th.

The scale Waa weighs each object from the special sorting end point SAus.3, wherein the scale Waa is operated in the second operating mode, and supplies a measured value in each case. This measured value is transmitted to the decision unit EE.

The decision unit EE checks whether this measured value is in the second weight class.

If the measured value which has been acquired in the second operating mode is in the second weight class, this measured value is used as the weight of the item of mail which has been measured in an MID-compatible fashion. The decision unit EE outputs the measured value, for example to the control unit SE. The measured value acquired in the second operating mode is added to the data record for the item of mail.

The item of mail is processed in the normal further processing and then set aside into one of the plurality of predefined sorting end points SAus.1, SAus.2.

If the measured value is not in the second weight class, the decision unit EE decides automatically that the weight of the item of mail is not in the second weight class, that is to say is either lower than 10 g or higher than the second upper weight threshold of, for example, 350 g. In the procedure described above, it was already previously decided that the item of mail does not have the first property either. The scale Waa is therefore not capable of weighing this object with a predefined tolerance in any operating mode. The item of mail is set aside and, for example, weighed manually or not weighed at all.

In one refinement of this first embodiment, in addition the value of a further physical parameter is used for the decision as to whether or not an item of mail to be weighed has the first property. Preferably a dimension (length, height, thickness) of the item of mail is used as a further parameter. It is possible to use a plurality a dimensions. This refinement is implemented, in particular, if the scale in the first operating mode is capable of weighing with the first tolerance and in an MID-compatible fashion only objects with specific dimensions.

In this refinement also, in the first pass all the items of mail are transported through the sorting system SAnl over the scale Waa. Furthermore, the at least one dimension is measured.

For example, a photoelectric barrier measures the period of time in which the transported item of mail interrupts the photoelectric barrier. The length of the item of mail is calculated—as viewed in the transportation direction—from this measured period of time and the transportation speed of the item of mail. The height of the item of mail is preferably measured by a plurality of photoelectric barriers located one above the other.

The thickness of the item of mail is, for example, measured by generating and evaluating an image which shows the item of mail from the front. In contrast, the upright item of mail is preferably transported between two distance sensors. Each distance sensor measures the distance between itself and the surface of the respective item of mail facing it. The thickness of the item of mail supplies the difference between the known distance and the distance which remains constant from the two distance sensors and the two measured distances.

The height and the length can instead be measured by evaluating an image, wherein this image shows the item of mail in an upright position from the side, that is to say in a viewing direction perpendicular to the object plane of the item of mail.

The measuring device MGer for the at least one dimension is mounted upstream or downstream of the scale. Both the respective measured value of the scale Waa and the dimension are transmitted to the decision unit EE.

A first partial range Dim-Tb.1 of the respective value range is predefined for each dimension which is used for the decision. In statistical investigations which were carried out in advance, this partial range Dim-Tb.1 was determined in such a way that the weight of an item of mail is generally in the first weight class if the dimension of this item of mail is in the partial range Dim-Tb.1. Or the partial range is predefined by the implementation of the scale Waa. Accordingly, a second partial range Dim-Tb.2 is predefined.

If every dimension of an item of mail to be weighed which is used for the decision is in the respective partial range Dim-Tb.1, the decision unit EE decides that in every case the scale Waa weighs this item of mail in the first operating mode, and the measured value which is acquired in the first operating mode is evaluated. If this measured value is then in the first weight class, the item of mail has the first property, and the measured value is used as the weight which has been measured in an MID-compatible fashion. On the other hand, if a dimension is outside the respective partial range Dim-Tb.1, the decision unit EE decides that this item of mail is to be set aside into the special sorting end point SAus.3 and is to be weighed in the second operating mode. Although in one embodiment this item of mail has previously been weighed by the scale Waa in the first operating mode, the measured value is not used as the weight of the item of mail which has been measured in an MID-compatible fashion.

After this decision, the steps described above are carried out. In order to decide whether or not an item of mail from the special sorting end point SAus.3 has the second property, the measured values which are acquired in the second operating mode are used by the scale, and in one embodiment in addition at least one dimension of the item of mail is used. In this embodiment it is checked whether the dimension is in the second partial range Dim-Tb.2.

Every item of mail from the special sorting end point SAus.3 is preferably weighed by the scale when it is being operated in the second operating mode, without a differentiation being previously made as to whether the item of mail has the second property or not. It is not decided until after the weighing whether the measured value can or cannot be used as the weight which has been measured in an MID-compatible fashion.

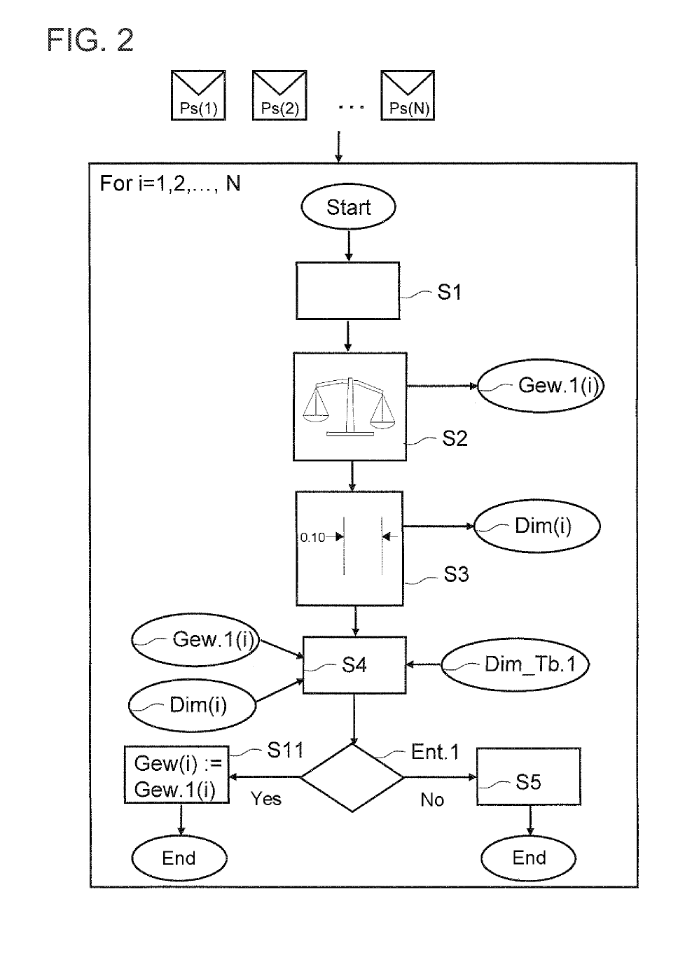

FIG. 2 shows a flowchart for the first embodiment in which each item of mail is transported over the scale Waa which is being operated in the first operating mode.

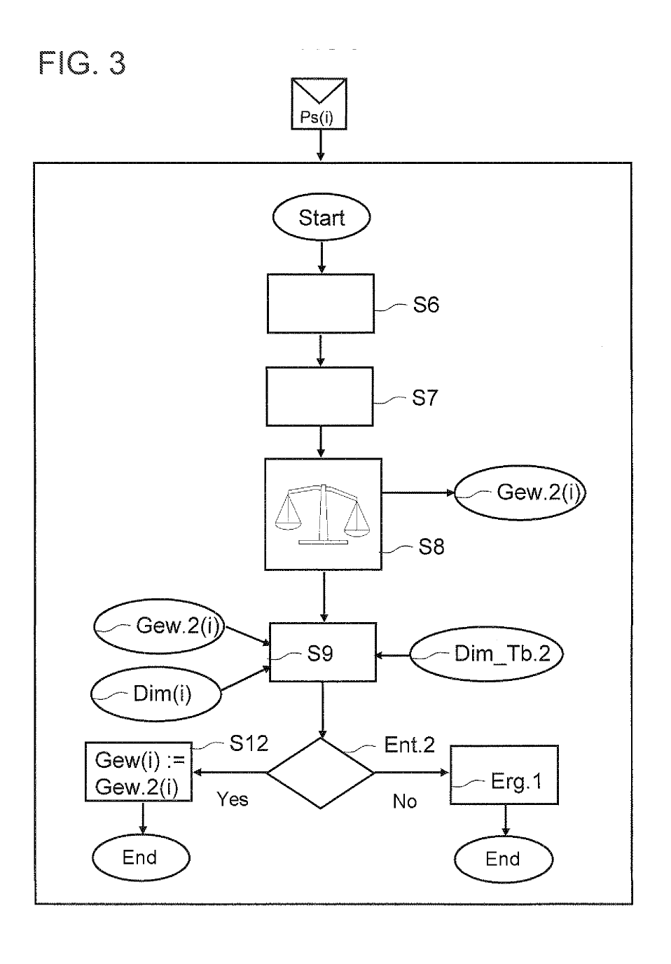

FIG. 3 shows a flowchart for the step from FIG. 2 for weighing an object in the second operating mode.

N items of mail Ps(1), Ps(2), . . . , Ps(N) are to be weighed. In the method which is shown by FIG. 2 and FIG. 3, the following steps are carried out for each item of mail Ps(i) (i=1, . . . , N):

S1: The item of mail Ps(i) is fed to the sorting system SAnl and is transported over the scale at the first transportation speed.

S2: The scale Waa weighs the item of mail Ps(i) in the first operating mode.

S3: The dimensions of the item of mail Ps(i) are measured. This supplies the dimensions Dim(i).

S4: It is checked whether or not the item of mail Ps has the first property.

Ent.1 Decision: does the item of mail Ps(i) have the first property?

S11: The weight Gew.1(i) which is measured in the first operating mode is used as the weight Gew(i) of the item of mail Ps(i) which has been measured in an MID-compatible fashion.

S15: The item of mail Ps(i) is weighed in the second operating mode. The steps which are carried out in the process are shown by FIG. 3.

S6: The item of mail Ps(i) is set aside into the specific sorting end point SAus.3 and fed again to the sorting system SAnl.

S7: The item of mail Ps(i) is transported over the scale Waa at the second transportation speed v2.

S8: The scale Waa weighs the item of mail Ps(i) in the second operating mode.

S9: It is checked whether or not the item of mail Ps(i) has the second property.

Ent.2 Decision: does the item of mail Ps(i) have the second property?

S12: The weight Gew.2(i) which has been measured in the second operating mode is used as the weight Gew(i) of the item of mail Ps(i) which has been measured in an MID-compatible fashion.

Erg.1 Result: the scale Waa is not capable of weighing the item of mail Ps(i) in an MID-compatible fashion.

The scale Waa therefore weighs an item of mail in the first operating mode when the decision unit EE has decided on the basis of the dimension that the dimensions of the item of mail do not preclude this item of mail having the first property. However, if the measured value from the scale Waa is not in the first weight class, the item of mail is set aside into the special sorting end point SAus.3 and weighed later by the scale when it is being operated in the second operating mode because this item of mail does not have the first property due to its weight.

Conversely, the case may occur in which, due to the dimension, the decision unit EE has already decided before the weighing that an item of mail is not in the first format class or probably not in the first weight class. The decision about the membership of the first format class can be made accurately after the dimensions have been measured. The decision about the membership of the first weight class is possible only on the basis of the experimentally acquired relationship between the weight and dimensions before weighing and is therefore possible only with probability.

After the weighing, it becomes apparent that the weight of the item of mail is indeed in the first weight class and the item of mail has the first property both in terms of its weight and in terms of its dimensions. In this case, the item of mail is weighed by the scale Waa when it is being operated in the second operating mode, even though when it is being operated in the first operating mode the scale Waa is also capable of measuring the weight of this item of mail in an MID-compatible fashion. Since the weight range of the second weight class almost completely covers the weight range of the first weight class, this embodiment nevertheless generally supplies a weight which has been acquired in an MID-compatible fashion.

In another refinement of the first embodiment, the situation is avoided in which the scale Waa weighs an object in the first operating mode which does not have the first property because it is too heavy, for which reason the scale Waa is not capable of measuring this object in an MID-compatible fashion.

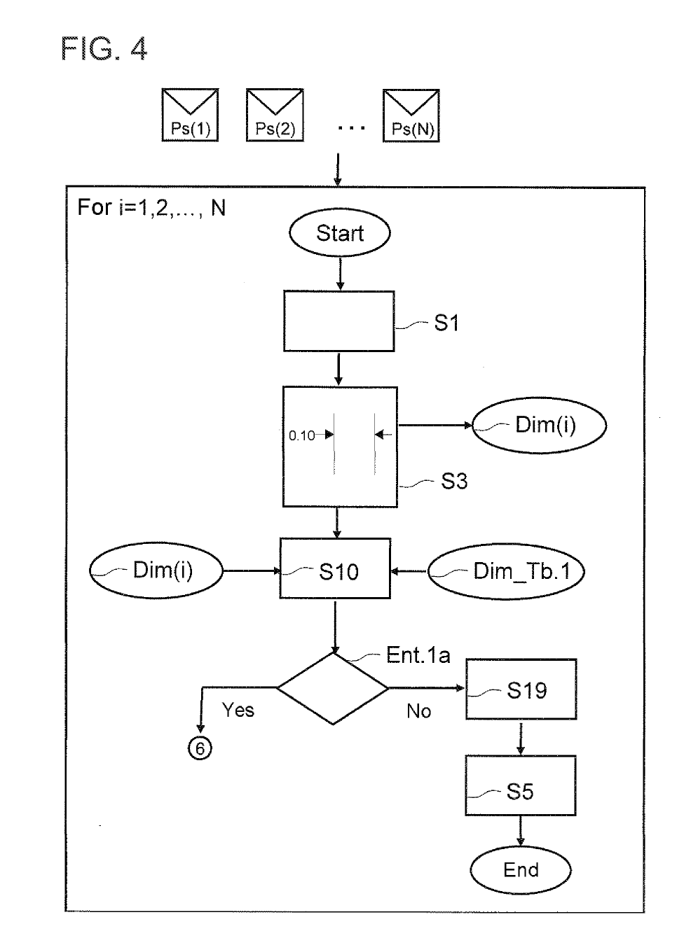

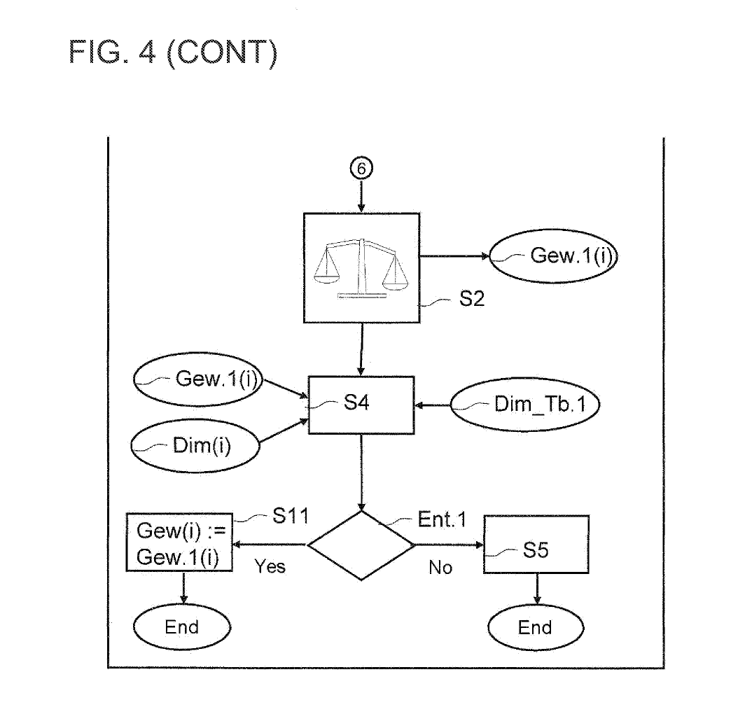

FIG. 4 shows a flowchart of a refinement in which, in the first operating mode, the scale Waa weighs only objects with the first property.

Identical reference symbols have the same meaning as the reference symbols in FIG. 2 and FIG. 3. In addition, in the method according to FIG. 4 the following steps are carried out:

S10: It is checked or predicted whether or not the item of mail Ps(i) has the first property. Only the dimensions Dim(i) of the item of mail Ps(i) are used for this checking operation or prediction, but the weight of that item of mail Ps(i) is not used.

S19: The item of mail Ps(i) is directed past the scale Waa when it is being operated in the first operating mode. Or the scale Waa is switched off and locked while the item of mail Ps(i) is being transported over the scale Waa.

Ent.1a Decision: is the item of mail Ps(i) being weighed in the first operating mode or not? This decision is made as a function of the checking operation or prediction S10, without the weight of the item of mail Ps(i) being already known.

In this refinement, the measuring device MGer for the at least one further physical parameter is disposed upstream of the scale Waa.

Every item of mail is initially transported past the parameter measuring unit and subsequently over the scale Waa. Every value of a further parameter, that is to say for example every measured dimension, is transmitted to the control unit. The decision unit EE decides, by evaluating these parameter values, whether or not the object has the first property, and the decision unit EE predicts approximately on the basis of the dimensions whether or not the weight of the item of mail is in the first weight class, without using a measured value from the scale for this prediction and decision.

In this other refinement, the control unit SE is capable of switching the scale Waa on and off. The scale Waa is preferably locked when it is switched off, and an object to be weighed cannot make the scale Waa experience natural oscillations which last for a long time. All the items of mail are successively transported over the scale Waa, wherein the scale is operated in the first operating mode. If the decision unit EE decides, on the basis of the previously measured dimensions of an item of mail and without knowing the weight of this item of mail, that this item of mail has the first property, the control unit SE ensures that the scale is switched on before the item of mail reaches the scale Waa. If necessary, the control unit SE switches the scale on and unlocks it. The scale Waa weighs the item of mail, and the measured value from the scale is used as the weight of the item of mail at least when the measured value is also in the first weight class. The item of mail has the first property both in terms of its dimensions and in terms of its weight.

If the measured value is outside the first weight class, the item of mail is set aside into the special sorting end point SAus.3.

On the other hand, if the decision unit EE already predicts on the basis of the dimensions that the weight of an item of mail will be expected to be outside the first weight class, or decides on the basis of the dimension that the item of mail does not have the first property, the control unit SE ensures that the scale Waa is switched off. If necessary, the control unit SE switches off the scale Waa and causes the item of mail not to reach the scale Waa until the scale Waa is switched off and locked. The item of mail is set aside into the special sorting end point SAus.3 without the scale Waa having weighed this heavy item of mail in the first operating mode.

The items of mail from the special sorting end point SAus.3 pass through the sorting system SAnl again. The scale Waa has previously been switched over to the second operating mode. The items of mail from the special sorting end point SAus.3 are transported over the scale Waa at the lower second transportation speed v2. In one embodiment, by evaluating the values of the further parameters, the decision unit EE decides whether or not the item of mail has the second property. The control unit SE switches the scale off in order to avoid the scale Waa weighing an item of mail which does not have the second property in the second operating mode.

On the other hand, in one preferred embodiment the scale Waa weighs, in the second operating mode, all the items of mail which originate from the special sorting end point SAus.3. The decision as to whether or not one of these items of mail has the second property is then made by the decision unit EE by evaluating the measured value which has been acquired from the weighing cell WZ in the second operating mode, and if necessary in addition to the dimensions. The scale Waa therefore weighs the item of mail when the scale is operating in the second operating mode, but the measured value from the weighing cell WZ is used as the weight which has been acquired in an MID-compatible fashion only in the case of a positive decision by the decision unit EE.

In all the variants of this first embodiment, all the items of mail pass through the sorting system SAnl in the first pass without previously having to be divided into two sets according to dimension or weight. All these variants function without a separating switch and without a “bypass” around the scale Waa.

In a second embodiment, the sorting system SAnl additionally has a separating switch which is disposed upstream of the scale Waa. A weighing transportation path and a bypass transportation path branch off from this separating switch. The weighing transportation path leads over the scale Waa, and the bypass transportation path leads around the scale Waa. In one embodiment, the weighing transportation path leads to a branching point from where further transportation paths lead to the weighing cells which are connected in parallel. The scale Waa is capable of weighing an object when the object is transported from the weighing transportation path over the scale or the weighing cells.

In one embodiment, the measuring device MGer for the further physical parameter is disposed upstream of the separating switch. This measuring device MGer measures, for example, a dimension of an item of mail which is to be sorted. These parameter values are transmitted to the decision unit EE. The decision unit EE predicts, by evaluating the dimensions, whether or not the weight of an item of mail is in the first weight class, and as a function of this prediction the decision unit EE makes a decision as to whether or not the scale weighs this item of mail in the first operating mode, because the item of mail is expected to have the first property. The decision unit EE transmits its decisions automatically to the control unit SE. The control unit SE actuates the scale as a function of this decision. The separating switch directs an item of mail having a weight which is in the first weight class into the weighing transportation path. Another item of mail is directed onto the bypass transportation path by the separating switch.

The scale Waa is in the first operating mode and weighs all the objects which, according to the prediction of the decision unit EE, have the first property and therefore, to be more precise: all the objects which are transported on the weighing transportation path over the scale. The bypass transportation path transports the other items of mail to the special SAus.3 sorting end point. These items of mail later pass through the sorting system SAnl again and are weighed by the scale Waa, wherein the scale Waa is operated in the second operating mode.

In another embodiment, the sorting system SAnl includes a so-called format separating apparatus, which is embodied, for example, as a rotating drum with slits. The items of mail are transported into the rotating drum. An item of mail then falls through a slit in the rotating drum if every dimension of the item of mail is below a respective limiting value. An item of mail which falls through the slit is transported to the scale on the weighing transportation path. An item of mail which remains in the drum is removed later from the drum and transported on the bypass transportation path. This bypass transportation path transports the item of mail into the special sorting end point. Such a format separating apparatus is described, for example, in German Patent DE 100 38 690 C1.

All the embodiments described heretofore ensure that every item of mail is weighed in a way which is MID-compatible. The measured weight can, when necessary, be used as legal evidence if disputes should occur between the carrier and the sender about the level of the necessary forwarding fee. This fails to apply only if the weight of the item of mail is neither in the first nor in the second weight class.

One refinement saves time because generally fewer items of mail have to pass through the sorting system SAnl again in this refinement. This refinement is used, in particular, for items of mail which have already been franked. A computer-compatible description of a tariff structure of the carrier is predefined. This tariff structure defines the fee-related parameters and respectively assigns a reference forwarding fee to the various combinations of value ranges of these parameters. For example, the tariff structure defines that a letter having dimensions which are within specific limits and having a weight which is between 20 g and 50 g can be franked with x cents of a dollar or Euro Cents.

At least one fee-related physical parameter which can be measured more quickly than the weight, for example a dimension, is predefined. Through the use of a preceding statistical investigation, a relationship is determined experimentally between this at least one parameter and the weight. The functional relationship is stored approximately.

Initially, all the items of mail to be weighed pass through the sorting system SAnl, as described above. The scale Waa is operated in the first operating mode. In the first sorting run, the following steps are preferably carried out for every item of mail:

The destination address of the item of mail is determined.

The actual forwarding fee with which the item of mail is provided is determined.

The at least one fee-related parameter which can be measured more quickly is measured, with this being preferably a dimension of the item of mail. For example, it is decided to which format class the item of mail belongs.

The decision unit EE or a special evaluation unit decides whether or not the item of mail is suspected of being under-franked or having insufficient postage. The weight is measured in an MID-compatible fashion only in the case of an item of mail of which this is suspected. For this reason, weighing is carried out in the second operating mode and therefore a renewed pass through the sorting system SAnl is carried out only in the case of an item of mail of which this is suspected and which does not have the first property. For the decision as to whether or not this is suspected of an item of mail, the determined destination address, the actual forwarding fee, the at least one parameter value which can be measured quickly and the functional relationship are evaluated. For example, it is decided that in the case of an actual forwarding fee of p and a format of x * y * z this is not suspected of the item of mail.

For an item of mail of which this is suspected, the scale Waa supplies, as described above, a measured value, specifically either in the first operating mode or in the second operating mode.

A weight which has been measured in an MID-compatible fashion is not required of an item of mail which is not suspected of being under-franked. For this reason, such an item of mail is processed further in a normal way in all cases and is not set aside into the special sorting end point SAus.3, and is therefore not weighed in the second operating mode either. The item of mail which is not suspected of being under-franked is either not weighed at all, or the measured weight of the item of mail is used only for further transportation of the item of the mail but not for checking the actual forwarding fee. In order to ensure that an item of mail which is not suspected of being under-franked is not weighed, this item of mail is transported past the scale Waa on a bypass transportation path, or the scale Waa is switched off while the item of mail is transported over the scale.

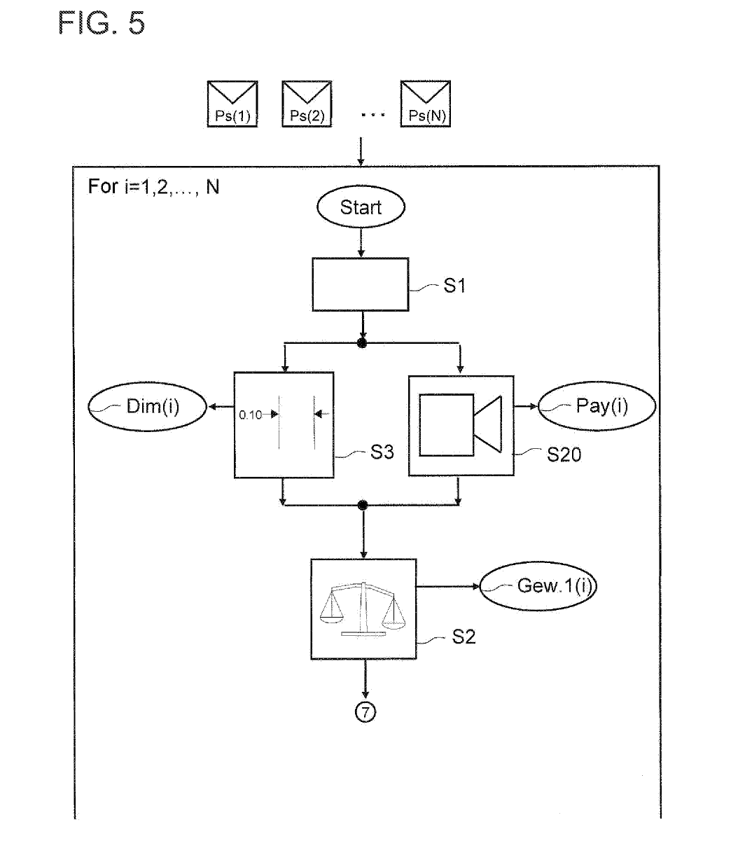

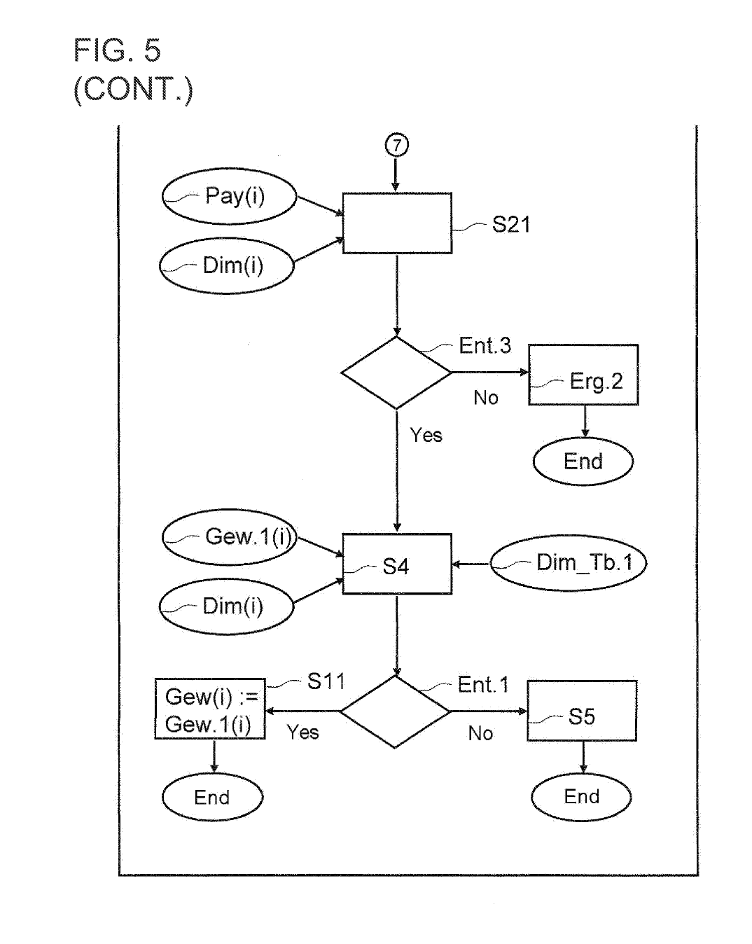

FIG. 5 shows a flowchart for a refinement in which only items of mail which are suspected of being under-franked are weighed in an MID-compatible fashion.

In the case of the method which is illustrated by FIG. 5, the following steps are additionally carried out:

S20: Determination of the actual forwarding fee Pay(i), with which the item of mail Ps(i) is provided.

S21: Checking whether the item of mail Ps(i) is categorized as being suspected of being under-franked, and should therefore be weighed in an MID-compatible fashion.

Ent.3 Decision: is the item of mail Ps(i) to be weighed in an MID-compatible fashion?

Erg.2 Result: a weight of the item of mail Ps(i) which has been measured in an MID-compatible fashion is not required.

The decision as to whether an item of mail is categorized as being suspected of being under-franked and is therefore to be weighed in an MID-compatible fashion is also made by the decision unit EE and depends on threshold values in the value ranges of the fee-related parameter and of the forwarding fee. These threshold values can be adjusted in order to find a desired compromise between the following two requirements:

The highest possible proportion of unfranked items of mail is to be weighed in an MID-compatible fashion.

The highest possible proportion of correctly franked items of mail is to be processed quickly.

1. A method for weighing at least one object, the method comprising the following steps:
providing a scale to be operated in a first operating mode and in a second operating mode;
operating the scale in the first operating mode for weighing, with a predefined first tolerance, any object having a first predefined physical property;
operating the scale in the second operating mode for weighing, with a predefined second tolerance, any object having a second predefined physical property;
carrying out at least one of the two following steps for each object to be weighed:
automatically checking whether or not the object has the first property, or
weighing the object with the scale upon operating the scale in the first operating mode;
weighing an object to be weighed in the first operating mode whenever:
deciding or predicting before the weighing in the first operating mode that the object has the first property, or
the step of checking whether or not the object has the first property was not carried out before the weighing in the first operating mode; and
when, for at least one object to be weighed:
the step of weighing the object with the scale in the first operating mode was not carried out, or
after the weighing of the object in the first operating mode it was decided that the object does not have the first property;
switching over the scale to the second operating mode;
for each object to be weighed which was not weighed in the first operating mode or does not have the first property, carrying out the step of weighing the object with the scale upon operating the scale in the second operating mode; and
using a value as the weight of each object to be weighed being:
a measured value measured in the first operating mode upon deciding that the object has the first property, and
a measured value measured in the second operating mode upon deciding that the object has the second property.

2. The method according to claim 1, which further comprises:
for each object which the scale has weighed in the first operating mode:
making a decision as to whether or not that object has the first property, and
using the measured value acquired in the first operating mode for the decision.

3. The method according to claim 2, which further comprises:
weighing each object to be weighed with the scale when the scale is operated in the first operating mode; and
for each object to be weighed, making the decision as to whether or not the object has the first property by using the measurement result from the scale.

4. The method according to claim 1, which further comprises:
predefining a further physical parameter and a partial range of the value range of the parameter;
respectively assuming a value for each object to be weighed with the parameter; and
including the parameter value checking operation in any checking operation to determine whether an object to be weighed has the first property, to determine whether or not the value which the parameter assumes for the object is in the partial range.

5. The method according to claim 4, which further comprises:
for each object to be weighed:
carrying out the checking operation to determine whether or not the object has the first property, and
carrying out the parameter value checking operation.

6. The method according to claim 5, which further comprises weighing the object with the scale when the scale is operated in the first operating mode when, and only when, the parameter value for the object is in the partial range.

7. The method according to claim 1, which further comprises including a step in which the object is transported over the scale or is transported along the scale in some other way without the object being stopped, in the step or each step in which the scale weighs an object to be weighed.

8. The method according to claim 7, which further comprises:
transporting the object at a first transportation speed, whenever an object to be weighed is transported along the scale when the scale is operated in the first operating mode;
transporting the object at a second transportation speed, whenever an object to be weighed is transported along the scale when the scale is operated in the second operating mode; and
setting the second transportation speed lower than the first transportation speed.

9. The method according to claim 1, which further comprises:
for each object to be weighed which has been weighed by the scale when the scale was operating in the first operating mode:
deciding after the weighing process, as a function of the measured value acquired in the first operating mode, whether or not the object has the first property; and
when the object which is weighed in the first operating mode does not have the first property, weighing the object with the scale when the scale is operated in the second operating mode.

10. The method according to claim 9, which further comprises:
weighing a plurality of objects with the scale in an initial step when the scale is operated in the first operating mode;
subsequently checking whether or not each object to be weighed has the first property; and
when at least one object to be weighed does not have the first property:
switching over the scale to the second operating mode, and
weighing each object which does not have the first property in the second operating mode.

11. The method according to claim 1, which further comprises:
predefining a destination to which each respective object to be weighed is to be transported;
determining which actual forwarding fee has been respectively paid for the transportation of the object;
predefining at least one further physical parameter;
performing a measurement for each predefined parameter and for each object to be weighed to determine which value the parameter assumes for the object;
automatically deciding, as a function of the determined actual forwarding fee and the at least one measured further parameter value, whether or not the object is weighed with a predefined tolerance; and
carrying out the step of weighing the object with the scale when the scale is operated in the second operating mode only if previously:
it has been detected that the object does not have the first property, and
it has been decided that the object is weighed.

12. A device for weighing at least one object, the device comprising:
a scale having at least one weighing cell;
said scale being operable in a first operating mode for weighing, with a predefined first tolerance, each object having a first predefined physical property;
said scale being operable in a second operating mode for weighing, with a predefined second tolerance, each object having a second predefined physical property; and
a decision unit for automatically deciding whether or not a weight of an object is in a first weight class;
said decision unit being configured to automatically check whether or not an object to be weighed has the first property and to automatically check whether or not an object to be weighed has the second property;
each object to be weighed being at least automatically checked as to whether or not the object has the first property or weighed with said scale operated in the first operating mode;
said scale weighing an object to be weighed with said scale being operated in the first operating mode whenever said decision unit has decided or predicted before weighing in the first operating mode that the object has the first property, or checking as to whether or not the object has the first property was not carried out before weighing in the first operating mode; and
said scale being switched over to the second operating mode when said scale has not weighed the object in the first operating mode, or said decision unit has decided, after weighing of the object in the first operating mode, that the object does not have the first property;
said scale operating in the second operating mode for weighing each object to be weighed having not been weighed in the first operating mode or not having the first property;
said decision unit being configured to decide that the object has the first property, for causing a value to be used as the weight of each object to be weighed, being a measured value measured in the first operating mode; and
said decision unit being configured to decide that the object has the second property, for causing a value to be used as the weight of each object to be weighed, being a measured value measured in the second operating mode.

13. The device according to claim 12, which further comprises:
a transportation apparatus for transporting an object to be weighed over said scale at a first transportation speed or at a second transportation speed being lower than the first transportation speed;
said transportation apparatus transporting an object to be weighed, without stopping the object:
at the first transportation speed over said scale being operated in the first operating mode, and
at the second transportation speed over said scale being operated in the second operating mode; and
said scale being configured to weigh an object being transported over said scale.
